(19) United States
(12) Patent Application Publication
(10) Pub. No.: US 2025/0349027 A1
(43) Pub. Date: Nov. 13, 2025

(54) MULTI-USER GAZE TRACKING IN A VEHICLE SPACE THROUGH EVALUATION OF IMAGING SOURCES AND OPTICAL SURFACE REFLECTIONS

(71) Applicant: Blink Technologies Inc., Palo Alto, CA (US)

(72) Inventors: Gilad DROZDOV, Haifa (IL); Oren HAIMOVITCH-YOGEV, Haifa (IL); Almog DAVID, Kiryat Motzkin (IL); Manuel Martin SALVADOR, Granada (ES)

(73) Assignee: Blink Technologies Inc., Palo Alto, CA (US)

(21) Appl. No.: 18/657,838

(22) Filed: May 8, 2024

(51) Int. Cl. G06T 7/73; G06T 7/00; G06V 10/82; G06V 40/16

(52) U.S. Cl. CPC G06T 7/73; G06T 7/0002; G06V 10/82; G06V 40/172; G06T 2207/20081; G06T 2207/20084; G06T 2207/30268; G06V 40/165

(57) ABSTRACT

Methods, systems, and storage media for performing multi-user gaze tracking in a vehicle space using multi-surface optical reflections are disclosed. Implementations may: acquire face and eye region image data of a plurality of occupants within a field of view of at least one camera associated with a vehicle; evaluate reflected image quality thresholds; locate and match occupants within the vehicle space; and perform eye tracking for multiple occupants independently via reflected multi-view images provided to a deep learning model.

### CROSS-REFERENCE TO RELATED APPLICATIONS

The present application is related to co-owned U.S. patent application Ser. No. 16/732,640 filed on Jan. 2, 2020 titled “GEOMETRICALLY CONSTRAINED, UNSUPERVISED TRAINING OF CONVOLUTIONAL AUTOENCODERS FOR EXTRACTION OF EYE LANDMARKS” by Haimovitch-Yogev et al.; and co-owned U.S. patent application Ser. No. 17/376,388 filed on Jul. 15, 2021 titled “PUPIL ELLIPSE-BASED, REAL-TIME IRIS LOCALIZATION” by Drozdov et al.; and co-owned U.S. patent application Ser. No. 17/298,935 filed on Jun. 1, 2021 titled “SYSTEMS AND METHODS FOR ANATOMY-CONSTRAINED GAZE ESTIMATION” by Drozdov et al.; and co-owned U.S. patent application Ser. No. 17/960,929 filed on Oct. 6, 2022, titled “MULTI-USER GAZE-TRACKING FOR PERSONALIZED RENDERING FROM A 3D DISPLAY” by Drozdov et al.; and co-owned U.S. patent application Ser. No. 18/657,826, filed concurrently herewith, titled “MULTI-USER OCCUPANT LOCATION DETERMINATION AND GAZE TRACKING IN A VEHICLE SPACE USING OPTICAL SURFACE REFLECTIONS” by Drozdov et al., which are all hereby incorporated by reference herein in their entirety as though fully set forth herein, to the extent that they are not inconsistent with the instant disclosure.

### FIELD OF THE INVENTION

The present application relates generally to face and gaze-tracking via digital cameras, and more specifically, to reflection-based imaging and eye tracking systems for improved eye tracking within a vehicle space.

### BACKGROUND

Gaze tracking or eye tracking technology as described herein can improve the user experience within a vehicle by enabling an eye tracking user interface or providing safety information about the occupants of a vehicle. These systems work by locating the point of regard of the occupants' eyes, thereby tracking the occupants' attention, and to some extent, their state of mind. The instant application also provides methods and systems for evaluating and selecting for processing only those image feeds that are useful in inferring accurately an occupant's point of regard. Informed selection of image feeds for processing by deep learning has the added benefit of increasing the efficiency of power usage by the eye tracking system and, in some instances, a reduction of the number of cameras placed in the vehicle. That is, by these methods and systems, less power will be spent on the analysis of substandard image data, conserving precious battery life in electric vehicles.

Eye tracking within an enclosed space such as a vehicle interior is dependent on variables that may detract from the imaging of eye regions that are important for accurate eye tracking. Examples of these variables include camera locations, camera angles, camera fields of view, camera resolution, lighting conditions, occupant movement, and others.

While the state of the art has been focused on direct imaging of occupants for eye tracking in vehicles, the instant inventors have discovered that the use of reflected images and deep learning models trained on reflected images can increase the accuracy and versatility of eye tracking, which is particularly useful inside vehicles that are bounded with reflective interior surfaces and one or more interior or peripheral cameras. The deep learning models disclosed herein are capable of the independent eye tracking analysis of multiple occupants of a vehicle, using multiple cameras via captured reflections.

Accordingly, the present application provides improved face landmark detection, eye tracking, and camera image evaluation for more accurate and efficient processing of occupant image data for eye tracking in vehicles.

### BRIEF SUMMARY

Embodiments of the present disclosure include deep learning systems for face detection, face landmark detection, and gaze tracking; as well as occupant location via camera triangulation, and camera output evaluation for multi-occupant gaze tracking in a vehicle space using multi-surface optical reflections.

In one embodiment, a method includes a method for performing multi-user gaze tracking in a vehicle space through multi-surface optical reflections, the method comprising:
a) receiving reflected image data of one or more occupants of a vehicle space;
b) based on the reflected image data, estimating the location of the one or occupants of the vehicle space; more
c) obtaining face image data, eye region image data, and head pose data from the reflected image data of one or more occupants of the vehicle space; and
d) using a deep learning model trained on vehicle space occupant reflection image data, performing eye tracking for at least one of the one or more occupants based on the face image data, the eye region image data, and head pose data.

In another embodiment, a method includes a method for performing gaze tracking in a vehicle space, the method comprising:
a) obtaining face image data, eye region image data, and head pose data for one or more occupants within a field of view of one or more cameras within a vehicle space, wherein the face image data, eye region image data, and head pose data is reflected from one or more surfaces within the vehicle space;
b) evaluating the face image data, the eye region image data, and the head pose data for image quality; and
c) for image data meeting or exceeding one or more image quality parameters, determining eye tracking information for each of the one or more occupants based on the face image data, the eye region image data, and head pose data.

### BRIEF DESCRIPTION OF THE DRAWINGS

FIG. 1 depicts a system environment in which various cameras positioned in and around a vehicle may be employed to capture direct or reflected images of vehicle occupants for use in determining occupant head location, gaze direction, or point-of-regard.

FIG. 2 depicts a series of direct and reflected image views of occupants for multi-user gaze inferencing system according to the instant application.

FIG. 3 depicts a series of reflected images showing a range of reflected image quality in a multi-user gaze inferencing system according to the instant application.

FIG. 4 depicts reflected image sample variations in a multi-user gaze inferencing system according to the instant application.

FIG. 5 depicts a basic input and data processing flow according to the present disclosure.

FIG. 6 depicts a schematic image processing flow according to the present disclosure.

FIG. 7 depicts a detailed block diagram illustrating a multi-user gaze or point-of-regard (PoR) estimation inference flow according to the present disclosure.

FIG. 8 depicts a block diagram illustrating an eye depth estimation inference flow according to the present disclosure.

FIG. 9 depicts a block diagram illustrating a multi-view approach for eye depth estimation according to the present disclosure.

FIGS. 10-11 are flowcharts illustrating methods for multi-occupant gaze tracking in a vehicle space using multi-surface optical reflections, according to certain embodiments of the present disclosure.

### DETAILED DESCRIPTION

Embodiments of the present disclosure include multi-user localization and gaze-tracking for occupants of vehicles using reflected images. Conventional direct camera imaging of vehicle occupants has certain limitations that in certain situations impedes of accurate gaze tracking (e.g., occlusions (such as hands or other objects in front of the face), direct sunlight on the camera sensor, wide or long distance head and eye positions of the occupant with respect to the camera, and others). It is envisioned herein that eye tracking accuracy may be improved, for multiple occupants, using one or multiple cameras to pick up images of the occupants from reflections inside the vehicle. This is made possible through occupant-specific point-of-regard estimation via gaze tracking of each occupant via reflected images, processed in parallel and using a deep learning model trained on reflected face and eyes images.

Implementations described herein provide a better eye tracking experience, with an efficient use of camera feeds according to image quality threshold gating. According to embodiments herein, eye tracking of multiple vehicle occupants is achieved by localizing the head of each occupant, e.g., via camera triangulation, and acquiring eye region image data of the occupants from reflections within a field of view of at least one camera operating inside or near the vehicle. Trained neural networks are then used to calculate point-of-regard for each occupant independently.

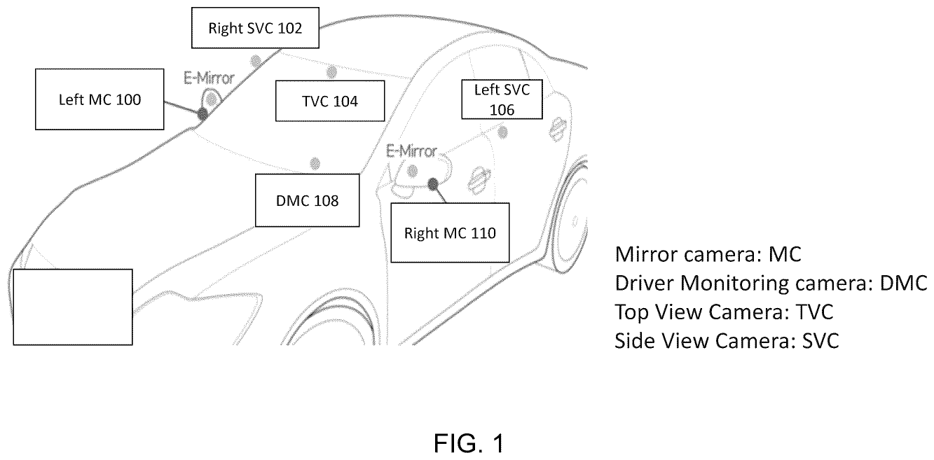

FIG. 1 depicts a system environment showing a vehicle equipped with various cameras, according to some embodiments of the present disclosure. Cameras such as Mirror camera: MC (left MC 100, right MC 110), Driver Monitoring camera: DMC 108, Top View Camera: TVC 104, and Side View Camera: SVC (left SVC 106, right SVC 102 may be positioned in or around the vehicle to capture direct and reflected images of vehicle occupants.

In some embodiments, images reflected in a digital mirror (also known as a virtual mirror, a smart mirror, or an e-mirror), may provide image data for the system, using cameras and a display. Digital mirrors often use computer vision, face detection, and face tracking to analyze visual patterns and represent digital information. Virtual mirrors typically collect, analyze, and make inferences from data from one or multiple images.

Interior or peripheral cameras may capture occupant reflected images that are useful in eye tracking when direct imaging fails to capture eye regions at a given point in time. In some embodiments, a combination of direct occupant images and reflected images of the occupant may provide superior image data for head location and eye tracking.

FIG. 1 shows a plurality of cameras, which may capture various perspectives of occupants directly or by reflections. Depending on where the occupants are located relative to the cameras and reflective surfaces inside the vehicle, the cameras may receive image data at different angles and distances for the different occupants. The different cameras' fields of view may encompass the same occupant, from different angles and via different reflections.

Accordingly, the occupants may be identified by the present system (e.g., via a digital signature or unique identifier for each occupant) and that identification shared between the separate cameras so that the system knows when the separate cameras are receiving images of the same occupant. Face detection may be carried out by a deep learning network as described below, e.g., a bounding box may be generated for each detected face, and a unique digital user identifier (DUI) may be assigned to each detected face as a mechanism for tracking which occupant should be shown which 3D images as their respective positions and gaze direction changes over time. The unique identifier may be associated with an occupant's face in an anonymized manner so as to not perpetuate a record of faces that would raise privacy concerns.

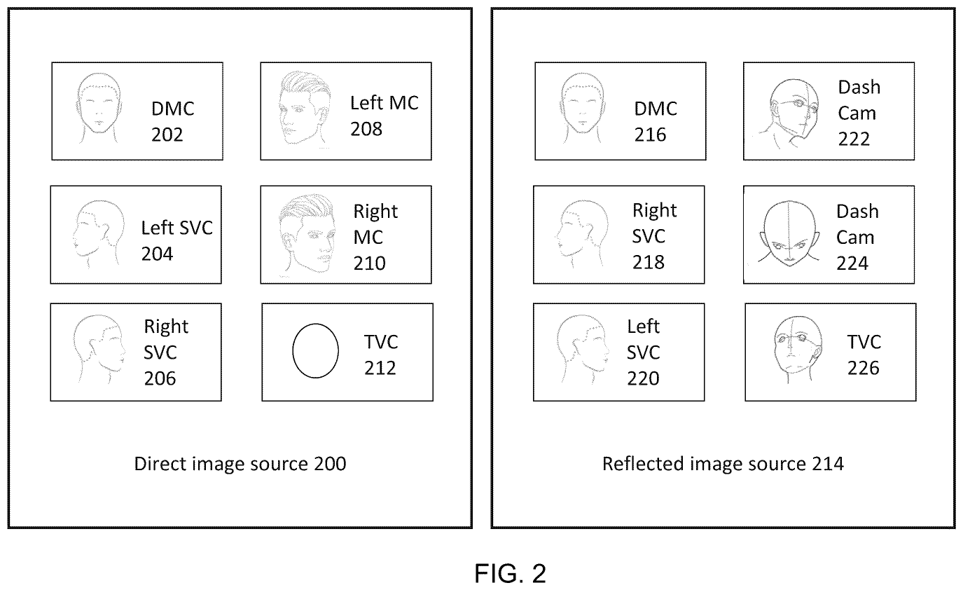

FIG. 2 depicts direct image source 200 and indirect image source 214, showing different perspectives of occupants that can be captured by the various cameras of FIG. 1. For example, the system may receive direct images of a driver from DMC 202, and additional indirect, reflected images of the driver from DMC 216.

Location of occupant information, including distance of the occupant from cameras is another aspect of the present disclosure. The systems depicted and described in this application are well suited to triangulating occupant head position based on image analysis from one or more cameras. This improves eye region localization and tracking for better eye tracking.

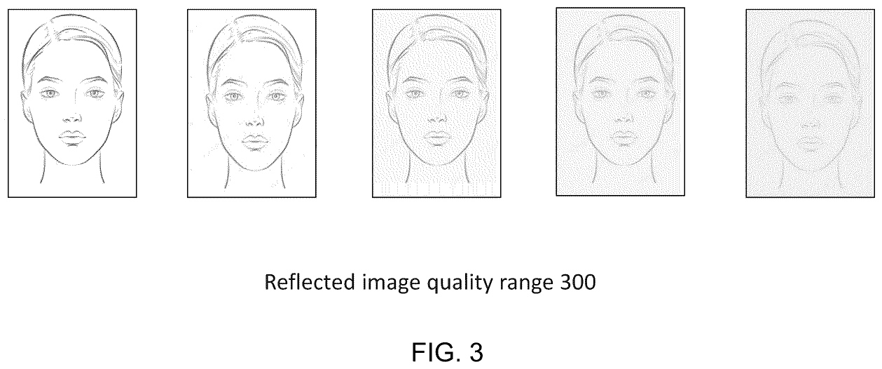

FIG. 3 depicts a series of reflections, showing reflected image quality range 300. As shown, reflection image quality may vary widely, and some reflections will not provide good data for eye tracking. Accordingly, as discussed below, embodiments of the present application may include evaluating reflected image data for quality thresholds so that poor images are not processed, which saves compute and power consumption by the system. This is an important consideration for electric vehicles, which rely on batteries for driving range.

Importantly, camera image feed evaluation can be done so that only camera image data that is usable to get consistently good imaging of both eyes of each occupant is selected. This conserves processing resources and bandwidth in situations in which, for example, an obstruction or lack of light makes the images from a given camera unusable in informing the deep learning systems in order to calculate occupant position, facial landmark, gaze direction, point of regard, or other parameter.

With a high number of direct and reflected images, the system will have a large number of images to select from, increasing the chances that good image data, with optimal viewing angles of the eyes, will provide for a better inference outcome from the deep learning model for more reliable eye tracking, particularly when it cannot be achieved via direct view (due to occlusion of the face, for example, as often happens when the camera is placed in the dashboard or instrument cluster of the vehicle).

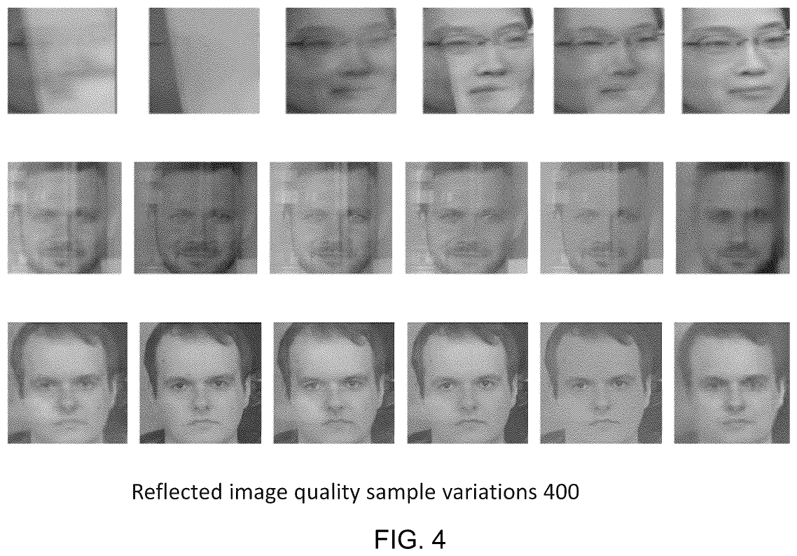

FIG. 4 depicts reflected image quality sample variations 400. These are sample images that show reflected image quality of varying degrees, under changing conditions. Some of these reflected images are of relatively good quality, e.g., the upper right and bottom row of images, whereas some are poor, e.g., the upper left two images.

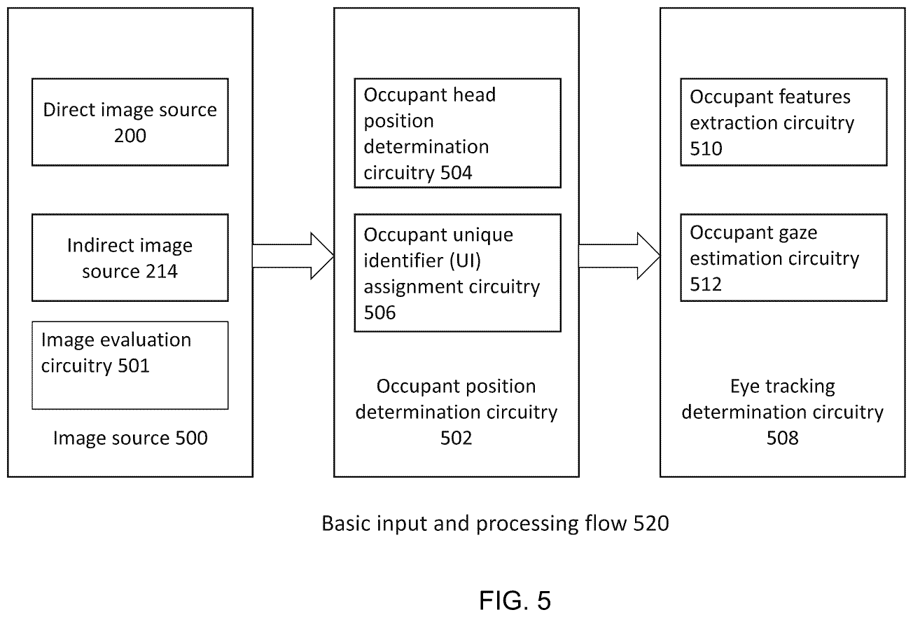

FIG. 5 depicts a basic input and processing flow for the instant application. Here, image source 500 provides either direct or indirect image data from direct image source 200 or indirect image source 214 to be used by occupant position determination circuitry 502 and eye tracking determination circuitry 508. Accordingly, occupant image data may be used by occupant head position determination circuitry 504 or occupant unique identifier (UI) assignment circuitry 506 for occupant location determination and discrimination.

Image evaluation circuitry 501 may be located with camera circuitry as shown, or separately, depending on system requirements. Image evaluation circuitry 501 may perform an evaluation of image data from each imager, in which each image feed is evaluated for its suitability in informing the eye tracking for each occupant. For example, this system may discard a camera's image data if there is no eye present in the images, saving processor cycles accordingly. The system may also eliminate redundancy in image data if two cameras are providing substantially similar images, and it can discard inferior image data, for example, images that are too dark, that are of too low resolution, which contain obstructed views of the eye, or other characteristics that will negatively affect eye tracking accuracy.

Image evaluation circuitry 501 may comprise a camera selector algorithm for different camera feeds. The algorithm may be programmed to evaluate the presence of an eye patch in image data from each camera, illumination level, reflection quality, and resolution. Evaluation may consider binary conditions, a range of values, or threshold values. For example, binary conditions indicating the presence of an eye patch, adequate illumination, and adequate resolution may result in acceptance of the image data from a camera for further processing in informing face and gaze tracking an occupant of the vehicle. However, if important parameters are missing or are at sub-threshold levels, the image data may be blocked from further processing. In some cases, however, a failure of one parameter may still result in overall use of the image data for further processing. For example, images from a camera whose image data has an eye patch, adequate illumination, but lower than desired resolution may still be acceptable and passed through for further processing.

Thus, the evaluation and selection of image feeds potentially avoids large amounts of wasted processing when poor images are being captured of the occupants. As discussed above, this may contribute small but significant power savings for electric vehicles.

Additional parameters that the camera selector algorithm can evaluate include occupant distance and angle relative to the cameras and reflections. If an occupant moves to an angle such that they are no longer providing either direct or reflected eye images, the camera selector algorithm may block those image feeds as lacking adequate image data to inform eye tracking inference.

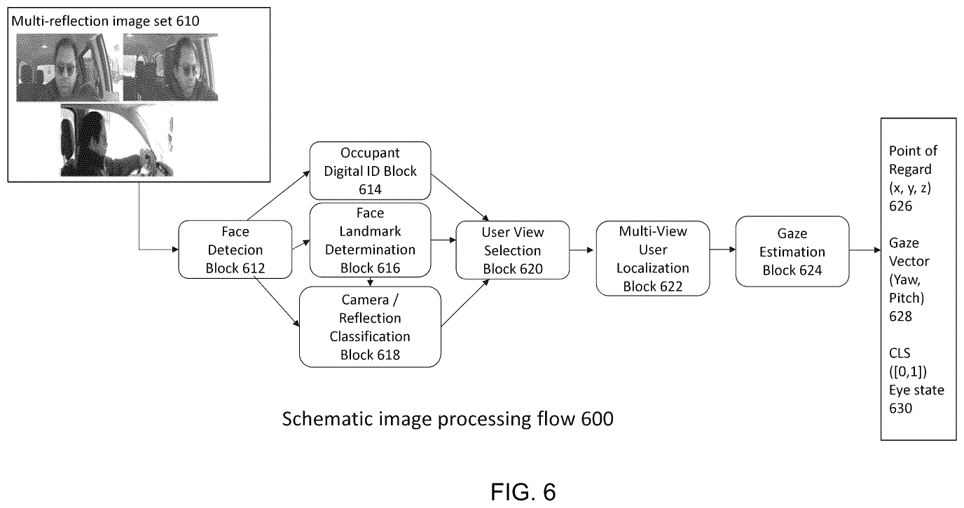

FIG. 6 shows a schematic image processing flow 600, in which multi-reflection image set 610 is provided to face detection block 612. Multi-reflection image set 610 may include direct images or reflected images, from one or multiple cameras. Face detection information may then be sent to occupant digital ID block 614 for assignment of a unique identifier to be used to track, and later localize, the identity of the occupant. Face detection information may also be sent to face landmark detection block 616 for face landmark analysis, as discussed in more detail below (see Facial Landmark Detection section below).

Face detection information may also be sent to camera/reflection classification block 618 for tracking of camera source and reflection location information with respect to each occupant. This information may then be used by user view selection block 620 to filter out image sources that do not provide user views that are suitable for eye tracking or other data analysis. For example, low quality reflection images or images that do not contain eye regions for occupants may be discarded from further processing, as they would not contribute to accurate head position, eye tracking, or other image analysis.

User view image data may then be passed to multi-view user localization block 622 for head position or other user localization analysis based on the image data for each occupant. For example, direct images and reflected images may be used to triangulate the location of the occupant (with the same digital occupant identifier), within the vehicle space based on known camera positions and distances.

Similarly, user view image data may be passed to gaze estimation block 624 for gaze tracking by a deep learning model, to provide indications of gaze such as point of regard (POR) in an x, y, z matrix (e.g., point of regard (x, y, z) 626); gaze vector (yaw, pitch) 628; and CLS (0, 1) eye state 630.

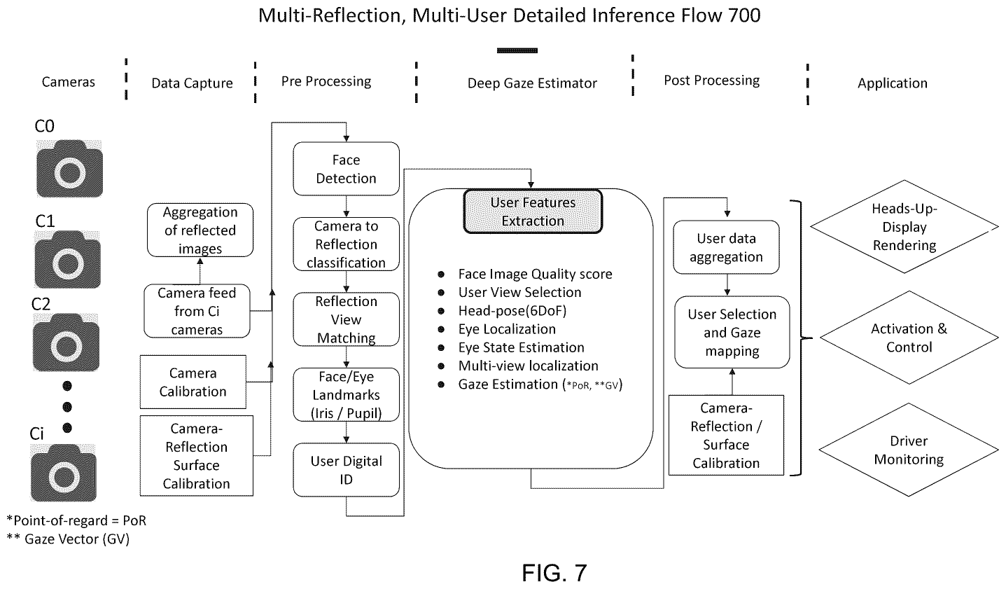

FIG. 7 is a high-level block diagram illustrating an example of a multi-reflection, multi-user detailed inference flow according to the instant application. In this example, multiple cameras may capture occupant image data, e.g., camera C0, camera C1, camera C2, up to camera Ci. Example data capture may include, but is not limited to camera feeds, camera calibration, and occupant location information. The term “camera calibration,” as used herein, refers to calibrating the cameras relative to the occupants and occupant positions in a vehicle space. In an example, the data may be pre-processed via face detection of multiple users, user selection, camera view matching (e.g., which camera works best for a particular occupant and/or timeframe), face/eye landmarks (e.g., iris or pupil), and head pose or location estimation. In an example, the number of vehicle occupants may be determined as a parameter to the system, and each occupant may be matched with one or more cameras with a field of view that is in a position to capture images of each occupant, or reflected images of each occupant. This camera view matching helps ensure that only the minimum number of cameras needed for providing good image data for each occupant are activated (and their image data processed), to reduce data transmission bandwidth requirements, and to reduce computation necessary to process the data.

Data capture may include aggregation of reflected or direct images from the feed from Ci cameras, camera calibration, and camera reflection surface calibration. Data capture information may then be passed to pre-processing steps, including face detection; camera-to-reflection or camera-to-occupant classification in terms of image quality, face detection, or occupant identification; reflection view matching; face or eye landmark detection, such as the iris or pupils; or assignment of a digital identifier for one or more occupants.

A deep gaze unit may be implemented to determine eye localization, eye state detection (e.g., blinks, eye movements, or eye fixations), gaze estimation, and tracking a digital ID to the face/eyes of each occupant. In an example, face identification may accommodate situations in which an occupant's face is obstructed (e.g., if an occupant is wearing a mask or is wearing glasses). Additional functions performed by the deep gaze estimator, or eye tracking deep learning model, may include providing a face image quality score, performing occupant view selection, providing occupant head position in six degrees of freedom (6DoF), eye localization, eye state determination or estimation, multi-view localization, or gaze estimation (e.g., PoR or gaze vector).

Post-processing may include user or occupant view selection, view optimization, user or occupant data aggregation, user or occupant selection and gaze mapping, or occupant-specific calibration, or camera/reflection surface calibration. View optimization may be based on parameters from neural networks such as DNNs or CNNs for gaze detection, or from occupant-specific calibration.

The eye tracking system may be configured for various applications, including heads-up display rendering, activation and control of programs via eye tracking as user interface for the occupants, or driver or passenger monitoring.

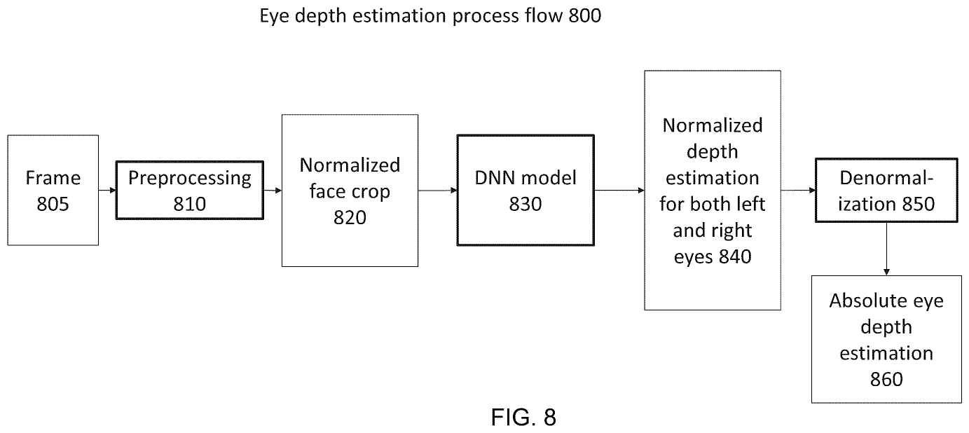

FIG. 8 shows an eye depth estimation process flow 800, in which an image frame 805 is passed through preprocessing to crop and enhance images to provide a normalized face crop 820. This improved image data containing eye regions may then be provided to DNN model 830 trained on diverse eye depth image data. DNN model 830 may output normalized depth estimation for both left and right eyes 840. The system may then denormalize the data at denormalization 850 in order to improve efficiency; absolute eye depth estimation block 860 may then provide gaze depth for one or more specific occupants.

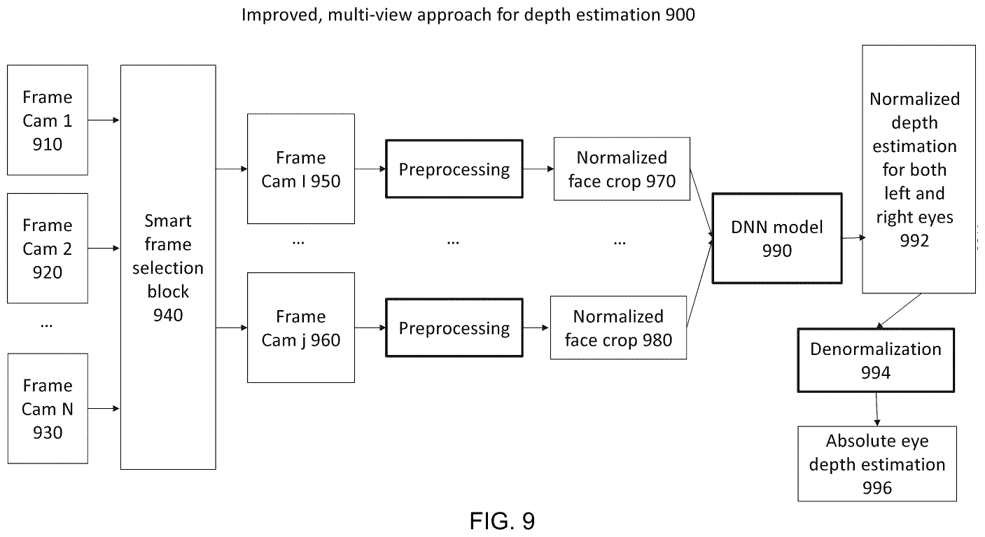

FIG. 9 shows an improved, multi-view approach for depth estimation 900, in which frames from various cameras (e.g., frame cam 1 910, frame cam 2 920, up to frame cam N 930) are provided to smart frame selection block 940. Smart frame selection block 940 will select the best image data from multiple views of a given occupant, for example, frame cam i 950 and frame cam j 960. Continuing this example, frame cam i 950 and frame cam j 960 are passed through preprocessing to crop and enhance images to provide normalized face crop 970 and normalized face crop 980. This improved image data may then be provided to DNN model 990 trained on multi-view eye or gaze depth image data. DNN model 990 may output normalized depth estimation for both left and right eyes 992. The system may then denormalize the data at denormalization 994 in order to improve query efficiency. Absolute eye depth estimation 996 for one or more specific occupants may then be carried out.

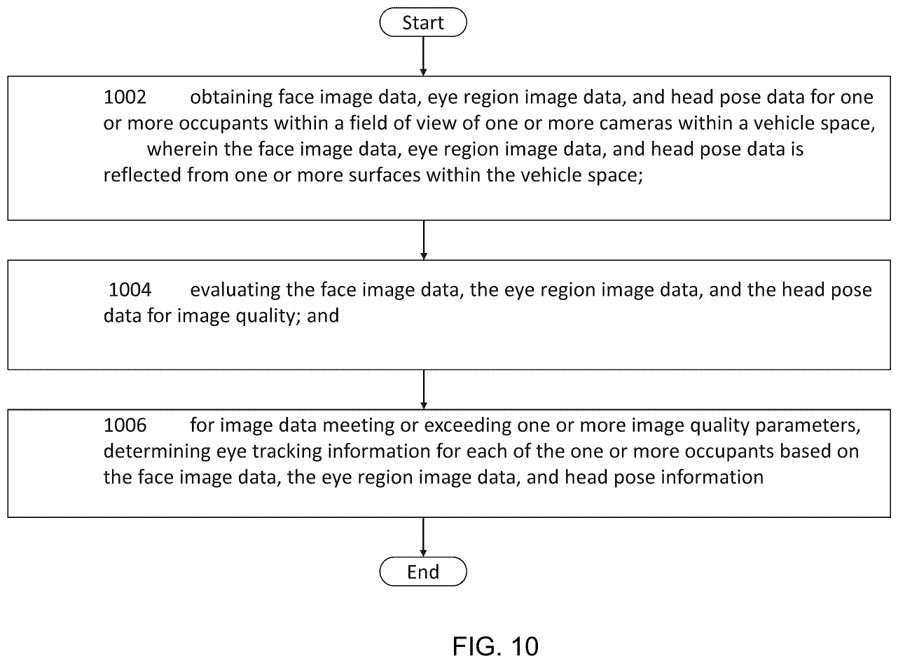

FIG. 10 is a flowchart that shows a computer-implemented method for performing multi-user gaze tracking in a vehicle space through multi-surface optical reflections, according to some embodiments of the present disclosure. At 1002, the method may include obtaining face image data, eye region image data, and head pose data for one or more occupants within a field of view of one or more cameras within a vehicle space, wherein the face image data, eye region image data, and head pose data is reflected from one or more surfaces within the vehicle space. More than one camera may be used to capture image data, for example, to combine image data from multiple vantage points. In some embodiments, the eye region image data may include at least one of pupil image data, iris image data, or eyeball image data.

By way of illustration, occupant eye position may include the distance of the occupant's eye from a camera, or the location of an occupant's eye ball(s) in an x, y, z coordinate reference grid representing the vehicle space. Accordingly, eye position may refer to the position of one or more occupant's eyes in space, for example based on the occupant's position relative to cameras monitoring the vehicle space. Gaze angle may vary based on whether the occupant is looking up, down, or sideways. Both 3D eye position and gaze angle may depend at least in part on the occupant's physical characteristics (e.g., height), physical position (e.g., sitting or reclining), and head position (which may change with movement).

Point-of-regard refers to a point within the vehicle that an occupant's eye(s) are focused on, for example, various surfaces, displays, or windows being viewed by the occupant's eyes at a given point in time. Point-of-regard may be determined based on gaze tracking, and occupant selection of objects in the environment via a user interface.

In some embodiments, the at least one gaze angle comprises yaw and pitch. Yaw refers to movement around a vertical axis. Pitch refers to movement around the transverse or lateral axis. In some embodiments, eye region image data may be analyzed by evaluating at least one eye state characteristic. In some embodiments, the eye state characteristic comprises at least one of a blink, an open state being either a fixation or a saccade (movement), or a closed state. The open state refers to an eye being fully open or at least partially open, such that the occupant is receiving visual data. The closed state refers to fully closed or mostly closed, such that the occupant is not receiving significant visual data. In some embodiments, acquiring eye region image data may be performed by a camera at a distance of at least 0.2 meters from each occupant. It is noted, however, that the occupant(s) may be located at any suitable distance from the cameras.

In some embodiments, obtaining eye region image data may be performed by at least one digital camera installed within the vehicle interior. Such cameras may be located within mirrors, the dashboard, the ceiling, or anywhere else within the vehicle interior. In some embodiments, obtaining eye region image data or other image data may be performed with or without active illumination.

At 1004, the method may include evaluating the face image data, the eye region image data, and the head pose data for image quality.

At 1006, the method may include: for image data meeting or exceeding one or more image quality parameters, determining eye tracking information for each of the one or more occupants based on the face image data, the eye region image data, and head pose information. In some embodiments, the determining eye tracking information for each of the one or more occupants based on the face image data, the eye region image data, and head pose information may include mapping the eye region image data to a Cartesian coordinate system and unprojecting the pupil and limbus of both eyeballs.

The Cartesian coordinate system may be defined according to any suitable parameters, and may include for example, a viewer plane with unique pairs of numerical coordinates defining distance(s) from the viewer to the image plane. In some embodiments, the method may include unprojecting the pupil and limbus of both eyeballs into the Cartesian coordinate system to give 3D contours of each eyeball. Unprojecting refers to defining 2D coordinates to a plane in a 3D space with perspective. In an example, a 3D scene may be uniformly scaled, and then plane may be rotated around an axis and a view matrix computed.

In some embodiments, the method may include detecting degradation in the eye region image data. Image quality in reflected images is an important consideration, and evaluating reflections for meaningful eye images may be critical for accurate eye tracking. For example, an occupant may move or turn at an angle to the camera or to a reflected surface, reducing the quality of reflected image data captured by a particular camera. In some embodiments, the method may include switching to a different camera based on the degradation in the eye region image data, or based on a determination that a particular camera's image feed is below a quality threshold or otherwise inferior. For example, another camera may have a better view of an occupant or a reflection of the occupant as the occupant turns his or her head or otherwise moves relative to the camera.

In some embodiments, the method may include analyzing the eye region image data for at least one of engagement with a vehicle surface, fixation, or saccade. For example, an occupant may be engaged with the content on a display in the vehicle, or the occupant may be looking out of the windshield. The occupant may become fatigued, for example, by having driven for a long a time, or otherwise being tired. The occupant may also not be paying attention to the road (e.g., if the occupant is distracted by a loud noise, a cell phone, someone else in the vehicle, etc.).

In some embodiments, the method may include assigning a unique digital identifier to each occupant. In some embodiments, the identifier may be associated with at least one sequence of image projections calculated for each occupant. The identifier may be any suitable sequence of numbers and/or characters and/or other data to identify, differentiate, or otherwise track the occupant.

In some embodiments, the method may include acquiring eye region image data of one or more occupants within a field of view of at least one camera associated with vehicle space. The field of view may be defined in two-dimensional or three-dimensional space, such as from side-to-side, top-to-bottom, and far or near. The method may include analyzing the eye region image data to determine at least one head position, 3D eye position, at least one gaze angle, and at least one point-of-regard for at least one occupant relative to at least one camera associated with the vehicle space, from which to estimate gaze direction or PoR. Input from more than one source (e.g., multiple cameras) may be received.

In some embodiments, the at least one gaze angle comprises yaw and pitch. Yaw and pitch may change as the occupant moves their eye, their head, or their position (e.g., moving side-to-side or toward or away from a camera or surface). In some embodiments, analyzing the eye region image data further comprises analyzing at least one eye state characteristic. In some embodiments, the eye state characteristic comprises at least one of a blink, an open state being either fixation or saccade, or a closed state. Blink may be defined by a threshold. For example, the eye state characteristic may ignore routine eye blinks, but trigger on multiple and/or slow eye blinks. In some embodiments, obtaining eye region image data may be performed by a camera at a distance of at least 0.2 meters from at least one of the plurality of occupants.

In some embodiments, obtaining eye region image data may be performed by at least one of a fisheye camera, a digital mirror camera, a smartphone camera, or a digital external camera.

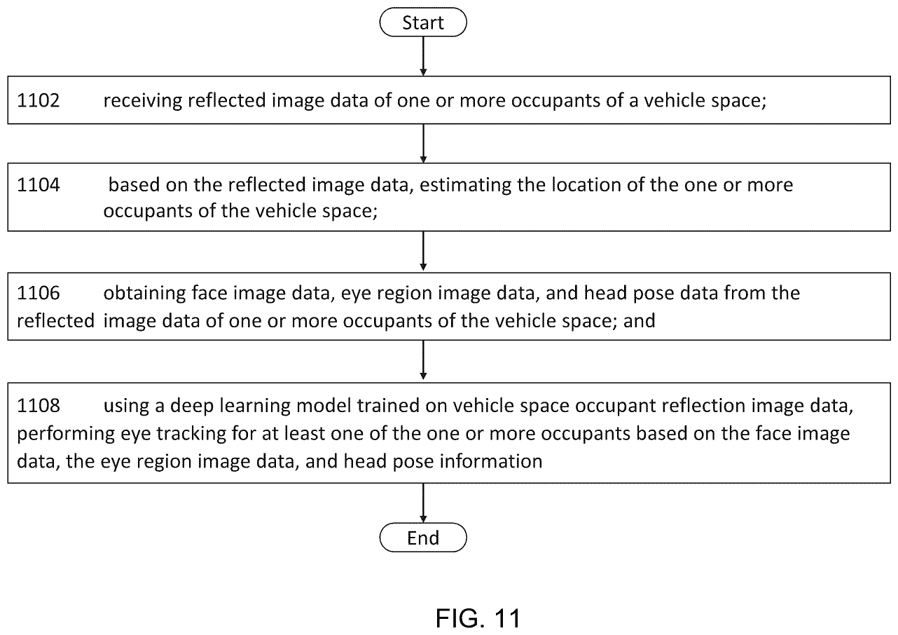

FIG. 11 is a flowchart that shows a computer-implemented method for performing gaze tracking in a vehicle space according to some embodiments of the present disclosure. At 1102, the method may include receiving reflected image data of one or more occupants of a vehicle space.

At operation 1104, the method may include based on the reflected image data, estimating the location of the one or more occupants of the vehicle space.

At operation 1106, the method may include obtaining face image data, eye region image data, and head pose data from the reflected image data of one or more occupants of the vehicle space.

At operation 1108, the method may include using a deep learning model trained on vehicle space occupant reflection image data, performing eye tracking for at least one of the one or more occupants based on the face image data, the eye region image data, and head pose information.

At 1104, based on the reflected image data, estimating the location of the one or more occupants of the vehicle space may include calculating a distance between at least one camera and at least one occupant using image analysis (See, e.g., K. A. Rahman, M. S. Hossain, M. A.-A. Bhuiyan, T. Zhang, M. Hasanuzzaman and H. Ueno, “Person to Camera Distance Measurement Based on Eye-Distance,” 2009 Third International Conference on Multimedia and Ubiquitous Engineering, 2009, pp. 137-141, doi: 10.1109/MUE.2009.34; https://ieeexplore.ieee.org/document/5319035.

Camera triangulation may also be used, wherein multiple cameras are used to triangulate the position of the same feature in images from each camera. To perform distance and depth analysis using camera triangulation, the first step may involve calibration of the cameras. This involves determining the intrinsic parameters of each camera, such as focal length and distortion coefficients, as well as the extrinsic parameters, which describe the position and orientation of each camera in a global coordinate system for the vehicle space.

Once the cameras are calibrated, the next step is to capture multiple images of the occupant from different positions. These images should overlap and contain enough common features for triangulation to work.

The next step is to extract and match features in the images. Features can be any distinctive points or patterns that can be easily identified in multiple images, such as corners or edges. Feature detection and matching algorithms, such as SIFT, SURF, or ORB, can be used to automatically detect and match features across images.

Once the features are matched, the position of a feature in 3D space can be computed by intersecting the lines of sight that pass through the feature, from each camera. This can be done using the Direct Linear Transformation (DLT) or Iterative Linear Triangulation (ILT) methods.

Once the 3D position of each feature is determined, it is possible to compute the distance and depth of objects or occupants in the vehicle. For example, if the cameras are positioned at a known baseline distance from each other, the distance to a feature can be computed by measuring the distance between the two camera positions and the 3D position of the feature.

Similarly, the depth of objects in the vehicle space can be determined by computing the distance of each feature to the cameras and then projecting the 3D positions onto the image plane of each camera. This results in a depth map of the vehicle space, making it possible to accurately determine the 3D position of the feature and therefore its distance from the cameras. See https://medium.com/@rohinfablabz/camera-triangulation-for-depth-and-distance-analysis-6e9da94cc9d7 and https://en.wikipedia.org/wiki/Triangulation_(computer_vision), incorporated herein by reference.

### Facial Landmark Detection

In some embodiments, facial landmark analysis may be performed, for example to distinguish one occupant from another for the purpose of assigning unique identifiers to each occupant in a vehicle space. Face data for analysis by the facial landmark detector may be obtained from any suitable source, as described above, such as images in a proprietary dataset or other image database. In one example, a facial landmark detector may perform farthest point sampling of the data for each session while using head rotation as the feature to sample. Data may include some variety of head poses, although most recordings use a frontal head pose. Data may also include faces from a wide variety of people. The dataset should include good image quality, a wide variety of head poses, a wide variety of people, and a wide variety of facial expressions.

An example data preparation process includes generating a ground truth by using a pre-trained landmark detector. Data preparation may also include generating emotion classification by using a pre-trained emotion recognition algorithm. Data preparation may also include computing a head pose using the detected landmarks.

In another example, the data may be filtered in such a way that only the images with “interesting” facial expressions are kept. The term “interesting” facial expressions as used in this context may include distinct expressions, common expressions, unusual expressions, or other category of expression depending on the desired output.

For each frame, the facial landmark detector may compute additional frames. For example, frames may be computed where the face bounding box is slightly moved in a random direction, in order to prevent the model from being limited to facial landmarks that are in the middle of a frame. Some frames that are sampled from the data may not have any faces in them. These frames may be used as negative examples to help the neural network understand the absence of a face.

As part of the training process, the facial landmark detector may use different data augmentation techniques. Example techniques may include random zoom in/out. This increases the model's ability to predict different face bounding box borders. Example techniques may also include random rotation. This increases the model's ability to predict different head poses. Example techniques may also include random translation. This also increases the model's ability to predict different head poses. Example techniques may also include impulse noise. This increases the model performance on noisy data. Example techniques may also include random illumination. This technique can be used to add an illumination effect to the image. Example techniques may also include a random black box as an obstruction or occlusion. This technique increases the model's ability to deal with occlusions.

In one example embodiment of the facial landmark detector model, the input to the model is a n×m (pixels) single-channel image. The image includes a face. An output is generated with Nx2, where N is the number of landmarks the model outputs. For each landmark, the facial landmark detector model predicts its X, Y location in the input frame. The output is normalized between 0 and 1. A binary classifier predicts whether there is a face in the input frame, and outputs a score between 0 and 1. In some embodiments, images of reflections of faces are used as training data to train a deep learning model.

The model architecture may include a common backbone that receives the image as input and produces an embedding of it. Landmarks may be split into different groups that share some similarities. Each head is fed by the common embedding, and outputs some subset of the landmarks. Each computed head has its own computation graph. Groups may include, for example, eyes, mouth, and exterior of the face. Using the groups helps the model to perform independent prediction of different facial landmark groups. These groups help the model to avoid biasing, do symmetry prediction, and compute some landmarks even though other landmarks are occluded. For example, the model works well on face images with masks, although the model never saw masks in the training process.

In some embodiments, the loss function is a variant of adaptive wing loss, but in some embodiments, the theta changes linearly during the training so the model is punished more on small errors as the training progresses. See Adaptive Wing Loss for Robust Face Alignment via Heatmap Regression; Xinyao Wang, Liefeng Bo, Li Fuxin; arXiv: 1904.07399; https://arxiv.org/abs/1904.07399; https://doi.org/10.48550/arXiv.1904.07399; hereby incorporated by reference.

In an example, the failure rate of images can be determined based on the normalized mean error (NME) being larger than some value (e.g., 0.1). Frames with large NME are considered to be frames on which the prediction failed.

### Gaze Estimation Methods and Systems Using Deep Learning

As described in U.S. patent application Ser. No. 17/298,935 titled “SYSTEMS AND METHODS FOR ANATOMY-CONSTRAINED GAZE ESTIMATION,” incorporated by reference herein, real-time methods and systems using non-specialty cameras are disclosed for providing a point-of-regard (POR) in a 3D space and/or 2D plane, based on user-personalized constrained oculometry (identified for each eye).

This is achieved, partly, through deep-learning-based, landmark detection of iris and pupil contours on recorded images obtained by the imaging module comprising an optical sensor that is directed toward the user, as well as deep-learning-based algorithm for estimating user's head pose with six (6) degrees of freedom (DOF), namely localization in 3D space (x, y, z) and angular positioning (pitch, yaw, roll)). Additionally, geometrical and ray tracing methods can be employed to unproject the iris and pupil contours from the optic sensors in the imaging module's plane onto 3D space, thus, allowing the system to estimate the personalized, user-specific eye (used interchangeably with “eyeball”) location (based on an initial geometry eyeball-face model, that relates between visible feature such as facial-landmarks to non-visible features such as eyeball center, refraction index, corneal-eyeball deviation, etc.) and gaze direction in the imaging module's space (e.g., Cartesian) coordinate system (in other words, a system of representing points in a space of given dimensions by coordinates). Likewise, the term “Cartesian coordinate system” denotes a system where each point in a 3D space may be identified by a trio of x, y, and z coordinates. These x, y, and z coordinates are the distances to fixed X, Y and Z axes. In the context of the implementations disclosed, the 3D coordinate system refers to both the 3D position (x, y, z) and 3D orientation (pitch, roll, yaw) of the model coordinate system relative to the camera coordinate system.

The components used for the operation of the system can be, for example, an imaging module with a single optical (e.g., passive) sensor having known distortion and intrinsic properties, obtained for example, through a process of calibration. These distortion and intrinsic properties are, for example, modulation-transfer function (MTF), focal-length for both axes, pixel-size and pixel fill factor (fraction of the optic sensor's pixel area that collects light that can be converted to current), lens distortion (e.g., pincushion distortion, barrel distortion), sensor distortion (e.g., pixel-to-pixel on the chip), anisotropic modulation transfer functions, space-variant impulse response(s) due to discrete sensor elements and insufficient optical low-pass filtering, horizontal line jitter and scaling factors due to mismatch of sensor-shift- and analog-to-digital-conversion-clock (e.g., digitizer sampling), noise, and their combination. In an exemplary implementation, determining these distortion and intrinsic properties is used to establish an accurate sensor model, which can be used for calibration algorithm to be implemented.

As part of the analysis of the recorded image, the left or right eye region of the user can be defined as the region encompassing the corners of the eye as well as the upper and lower eyelids, having a minimal size of 100×100 pixels, in other words, each of the left, and right eyes' region comprises a quadrilateral polygon (e.g., a rectangle) of at least 100 pixels by 100 pixels extending between the corners of each eye as well as between the upper and lower eyelids, when the eye is open.

To build an accurate eye model, the locations of the iris of both eyes is established in a 3D coordinate system in which the eyeball center is fixed. The head pose coordinate system can serve as the basis for establishing the iris location. In an example, an eye-face model—the location of both eyeball centers is determined in head coordinates (with regard to facial landmarks). An example of a pseudo code for the algorithm of the eye-model building is:

### Eye Face Model Building Example:

### Input:

{F}_{i=1 . . . N}—N Image Frames
C—Camera's Intrinsics, projection matrix and distortion coefficients
K—Camera Matrix

### Output

E_{L}, E_{R}—Left and Right Eyeball centers
IE_{L}, IE_{R}-iris—Eye center offsets

### Algorithm:

1. For each Frame, F
   a. ←IntrinsicDistortionCorrection (Fᵢ, C)
      Was done by multiplying with a camera projection matrix in order to bring the data to a similar form to what the network knows how to handle.
   b. {LP}_{j,eye}, R_{H}, T_{H},
   Landmarksᵢ←HeadposeLandmarkIrisDetection (\tilde{F}ᵢ)
      Was done by deep neural networks. R_{H}, T_{H} denote head rotation and translation respectively.
   c. For each eye:
      i. ProjectedIrisEllipse (a, b, ϕ, x_{c}, y_{c})←EllipseFitting ({LP}_{j,eye})
   The iris was estimated as a circle mapped to an ellipse by the camera's projection:
      ii. IrisCone_{CCS}←Unproject(ProjectedIrisEllipse, K) (307a)—Produces a cone in Camera's Coordinate System which is the result of multiplying the projected ellipse points with the inverse of the camera projection matrix (each point is mapped to a line in 3D).
      iii. IrisCone_{HCS}—ApplyRotationTranslation (R_{H}, T_{H}, IrisCone_{CCS})
      This stage was done to bring the cone (and by extension the Iris circle) to a coordinate system in which the eyeball center is fixed
      {3DIrisCircle_{HCS}}_{+,-}←CircularConeIntersection (IrisConeHCS, r_{I})

As specified in the step (i) hereinabove; the Iris circle was brought to a coordinate system in which the eyeball center was fixed, which was done assuming that the iris is a circle positioned on the surface of the eyeball sphere (which projection results in the ellipse detected by the camera). Thus the circular intersections with the cone, were its possible locations; and using rI-6 mm-population mean (of iris' dimensions) resulted in 2 possible iris circles—denoted +,−. The Iris (Circle) rotation angles were then denoted n, ξ.

2. {E, Reye} EyeEL,R′i←Swirsky ({{3DIrisCircleHCS}+, −}i=1N)

An initial guess for eyeball centers and Radii was achieved using the algorithm specified in [2]—for each eye the Iris circles was found, which a normal vector intersects in a single point, and that point. The eyes' rotations (i) was also obtained-which are the Iris circle normal in the head coordinate system:

In this step, the (rotated) eye model was obtained from the head coordinate system and the projection operator was computed by first applying rotation and translation with RH−1, −T_{H} followed by multiplication with the camera projection matrix K of the 3D eye, while Ri was the established eye rotation in every frame Fᵢ—also applied using matrix multiplication of the simplified 3D eye model (a sphere of radius reye with limbus in radius IE centered at E_{R},L). These parameters defined the (hidden from camera) eyeball center positions with regard to head-pose, and thus mapping to the facial landmarks which allowed the inference of the eyeball center from the camera-detected visible landmarks.

The process was repeated for both eyes resulting in E_{L}, E_{R}, IE_{L}, IE_{R} leading to a personalized parameter of the locations of both eyes as related to each other, constrained anatomically by the eyeball centers.

For example, the algorithm used for eye region localization can comprise assigning a vector to every pixel in the edge map of the eye area, which points to the closest edge pixel. The length and the slope information of these vectors can consequently be used to detect and localize the eyes by matching them with a training set (obtained ion the intrinsic calibration phase). Additionally, or alternatively, a multistage approach may be used for example to detect facial features (among them are the eye centers, or pupils) using a face detector, with pairwise reinforcement of feature responses, and a final refinement by using an active appearance model (AAM). Other methods of eye region localization can be employed, for example: using edge projection (GPF) and support vector machines (SVMs) to classify estimates of eye centers using an enhanced version of Reisfeld's generalized symmetry transform for the task of eye location, using Gabor filters, using feature triplets to generate a face hypothesis, register them for affine transformations, and verify the remaining configurations using two SVM classifiers, and using an eye detector to validate the presence of a face and to initialize an eye locator, which, in turn, refines the position of the eye using the SVM on optimally selected Haar wavelet coefficients. These methods can be used either alone or in combination with the face detection algorithm.

The face detection algorithm may be further used to compute head pose in six degrees of freedom (6DoF). Some exemplary methods for estimating head pose localization and angular orientation can be a detector array method (DAM), in which a series of head detectors are trained, each configured to classify a specific pose and assign a discrete pose to the detector with the greatest support, a technique using machine learning and neural networks. This method can be supplanted or replaced by Nonlinear Regression Methods (NRM), which estimates head pose by learning a nonlinear functional mapping from the image space to one or more pose directions, normally using regression tools and neural networks. Additional methods can be, for example: a flexible algorithm, in which a non-rigid model is fit to the facial structure of the user in the image and wherein head pose is estimated from feature-level comparisons or from the instantiation of the parameters, using the location of extracted features such as the eyes, mouth, and nose tip to determine pose from their relative configuration, recovering the global pose change of the head from the observed movement between video frames then using weighted least squares on particle filtering to discern the head pose. In an exemplary implementation, the head pose determination method used may be a hybrid method, combining one or more of the aforementioned methods to overcome the limitations inherent in any single approach. For example, using local feature configuration (eyes, nose tip, lips, e.g.,) and sum of square differences (SSD) tracking, or principal component analysis comparison and continuous density hidden Markov modeling (HMM). The existing models are additionally extended to include, for example eyeball landmarks, both visible (e.g., pupil-center, pupil contour and limbus contour) as well as non-visible (e.g., eyeball center, iris-corneal offset, cornea major axis). These are determined through a calibration process between the visible facial-eye landmarks (or feature) to the non-visible face-eye landmarks (or features) through a process of fixation, or focusing, by a subject on a known target presented to the subject. The final outcome of this procedure is a personalized face-eye model (which is configured per-user) that best estimates the location of the visible and non-visible landmarks (or features) in the sense of Gaze-reprojection (matrix)-error (GRE).

In an exemplary implementation, using DNN architecture of stacked hourglass is used because of the need to make the system user specific, implying the ability to capture data over numerous (application-specific) scales and resolutions. Thus, the DNN can consist of, for example, at least three (3) Stacked Hourglass heat-maps, in three pipelines; one for the face (a scale larger than the eyes landmark localizing), left eye, and right eye modules (L and R eyes-same scale), with an input of eyes region image, each of at least the size 100 by 100 pixels in another implementation.

In the context of the disclosed methods, systems and programs provided, the term “stacked hourglass” refers in some implementations to the visualization of the initial sampling followed by the steps of pooling and subsequent convolution (or up-sampling) used to get the final output of the fully connected (FC) stack layers. Thus, the DNN architecture is configured to produce pixel-wise heat maps, whereby the hourglass network pools down to a very low resolution, then reconvolutes and combines features across multiple resolutions.

In an exemplary implementation, for each eyeball region that was successfully located by the detection algorithm, the DNN outputs the subject's iris and pupil elliptical contours, defined by the ellipse center, radii of ellipse, and their orientation. In addition, for each face image that was successfully located by the detection algorithm, the DNN outputs the subject's head location in 3D space (x, y, z, coordinates) in the camera coordinate system as well as the subject's roll, yaw, and pitch. Additionally, another DNN receives as an input the face region to train on estimating the gaze direction and origin. This DNN consists of a convolutional layer, followed by pooling, and another convolution layer which is then used as input to a fully connected layer. The fully connected layer also obtains input from the eye-related DNN.

The instant gaze estimation (interchangeable with point of reference or point-of-regard (POR)) system is of high-precision (less than 1 degree of error accuracy referring to the angular location of the eye relative to the optic sensor array).

In some implementations, computing platforms may be configured to communicate with one or more remote platforms according to a client/server architecture, a peer-to-peer architecture, cloud architecture, or other architectures. Remote platforms may be configured to communicate with other remote platforms via computing platforms and/or according to a client/server architecture, a peer-to-peer architecture, cloud architecture, or other architectures. Users may access gaze tracking systems via remote platforms. It is noted that the computing platform may be integrated with a vehicle's electronics, or provided physically separately but in communication with the electronics of the vehicle. In some embodiments, a gaze tracking computing platform may be located in a cloud environment (e.g., public, private, or hybrid clouds).

A gaze tracking computing platform may include one or more processors configured by machine-readable instructions that are configured to implement the camera feed evaluation, occupant location determination, gaze tracking, and other methods described herein. Machine-readable instructions may include one or more instruction sets. The instruction sets may include computer program sets. The instruction sets may perform one or more functions when executed on a computing system, including acquiring eye region image data, e.g., by using a camera to obtain images of an occupant; analyzing eye region image data to obtain gaze tracking or PoR estimates, e.g., using the algorithms described above; detecting image degradation; camera switching; occupant identifier assignment; occupant selection; camera assignment; camera-to-reflection or camera-to-occupant distance calculation; and/or other instruction sets.

Eye region image data may be from multiple occupants within a field of view of at least one camera associated with a vehicle space. Any suitable camera may be provided, including but not limited to cameras for recording or processing image data, such as still images or video images. Acquiring eye region image data may be performed by a camera at a distance of at least 0.2 meters from at least one of the plurality of occupants. Suitable distances may include acquiring eye region image data at a distance from about 0.2 meters to about 3 meters. In some implementations, by way of non-limiting example, acquiring eye region image data may be performed by at least one of a digital mirror, a fisheye lens camera, a 360 degree view camera, a smartphone camera, or other digital camera. A smartphone camera may be any camera provided with a mobile device such as a mobile phone or other mobile computing device. A digital external camera may include any other stand-alone camera including but not limited to a surveillance camera, or a body-mounted camera or wearable camera that can be mounted or otherwise provided on a person (e.g., on glasses, a watch, or otherwise strapped or affixed to the occupant). In some implementations, acquiring eye region image data may be performed with active illumination. In other implementations, acquiring eye region image data may be performed without active illumination. Active illumination may include a camera flash and/or any other suitable lighting that is provided for the purpose of image capture separate and apart from artificial or natural lighting of the surrounding environment. By way of non-limiting example, the eye region image data may include at least one of pupil image data, iris image data, or eyeball image data.

For example, pupil image data, iris image data, and eyeball image data may be obtained from images of the occupants. Pupil image data may refer to the data regarding the occupant's pupil, or the darker colored opening at the center of the eye that lets light through to the retina. Iris image data may refer to data regarding an occupant's iris, or the colored part of the eye surrounding the pupil. Eyeball image data may refer to data regarding any portion of an occupant's eyeball, including the sclera, the limbus, the iris and pupil together, or the area within the neurosensory retina (the portion of the macula responsible for capturing incident light).

Analyzing eye region image data may be involve analyzing the eye region image data to determine at least one 3D eye position, at least one gaze angle, and at least one point-of-regard for at least one occupant relative to at least one camera associated with a vehicle space. The at least one gaze angle may include yaw and pitch. By way of non-limiting example, analyzing the eye region image data to determine at least one 3D eye position, at least one gaze angle, and at least one point-of-regard for at least one occupant relative to at least one camera associated with a vehicle space may include mapping the eye region image data to a Cartesian coordinate system. By way of non-limiting example, analyzing the eye region image data to determine at least one 3D eye position, at least one gaze angle, and at least one point-of-regard for at least one occupant relative to at least one camera associated with a vehicle space may include unprojecting the pupil and limbus of both eyeballs onto the Cartesian coordinate system to give 3D contours of each eyeball. The limbus forms the border between the cornea and the sclera (or “white”) of the eyeball.

Camera switching may include switching to a different camera based on the conditions or degradation in the eye region image data. For example, another camera may have a better or worse view of an occupant or the occupant's reflected images as the occupant turns his or her head or otherwise moves relative to the camera.

Identifier assignment may include assigning a unique identifier such as a digital identifier or a digital embedding identifier to each face corresponding to each occupant within a vehicle space. The identifier may be associated with at least one sequence of image projections calculated for each occupant. Any suitable identifier may be used, such as alphabetical and/or numerical sequence(s), bits, or other coded means of identification. Identifiers may be predefined or defined based on a calculation or determination of a processing algorithm. By way of these identifiers, multiple occupants can be tracked relative to cameras associated with vehicle space, and eye tracking conducted on each independently.

Occupant selection may include selecting at least two occupants based on at least one property of an array of cameras, such as combined field of view; or based on at least one eye property of the at least two occupants of the vehicle.

Camera assignment may include assigning at least one camera to at least one occupant based on an assessment of which camera among a plurality of cameras has the best viewing angle or imaging conditions of an eye region of at least one occupant. Assessment may be any suitable evaluation or estimation of the nature or quality of the imaging conditions, such as lighting, distance, resolution, obstruction or lack thereof, movement or lack thereof, or camera zoom capability. Imaging conditions may include the ability of the camera to capture imaging data and may be based on any of a variety of different factors, such as physical conditions of an occupant, environmental conditions, vehicle dimensions, or the nature of the reflective surfaces in the vehicle space.

Distance calculation may be configured to calculate a distance from at least one camera to at least one occupant, for example using image analysis or camera triangulation. Any suitable image analysis may be implemented, such that meaningful information is extracted from digital images via algorithmic analysis and processing of data captured by the camera(s).

### Location Determination Clauses

Clause 1: A computer-implemented method for performing multi-user gaze tracking in a vehicle space through multi-surface optical reflections, the method comprising:
receiving reflected image data of one or more occupants of a vehicle space; based on the reflected image data, estimating the location of the one or more occupants of the vehicle space;
obtaining face image data, eye region image data, and head pose data from the reflected image data of one or more occupants of the vehicle space; and
using a deep learning model trained on vehicle space occupant reflection image data, performing eye tracking for at least one of the one or more occupants based on the face image data, the eye region image data, and head pose data.

Clause 2: The computer-implemented method of clause 1, wherein the receiving reflected image data of one or more occupants of a vehicle space comprises:
receiving reflected image data of one or more occupants of a vehicle space by one or more cameras.

Clause 3: The computer-implemented method of clause 2 wherein the one or more cameras comprises:
at least one of a digital camera with a wide field-of-view (FOV), a plurality of cameras directed at one or more reflective surfaces within the vehicle space, or a plurality of cameras capturing one or more of direct and reflected images of the one or more occupants.

Clause 4: The computer-implemented method of clause 1, wherein the b) based on the reflected image data, estimating the location of the one or more occupants of the vehicle space comprises:
selecting one or more optimal views of each of the one or more occupants; and
estimating a position of at least one of the one or more occupants based on the selecting one or more optimal views of each of the one or more occupants, for multi-view localization.

Clause 5: The computer-implemented method of clause 4, wherein the multi-view localization is performed using reflected image data captured by a single camera.

Clause 6: The computer-implemented method of clause 1, wherein the reflected image data comprises data from at least one of a diffuse surface or a specular surface.

Clause 7: The computer-implemented method of clause 1, wherein the reflected image data comprises:

reflected image data from one or more of a highly reflective surface, a mirrored surface, a metal-coated surface, or a reflective plastic surface.

Clause 8: The computer-implemented method of clause 2, wherein at least one of the one or more cameras is configured to capture within its field of view one or more surface reflections of at least one occupant of the vehicle space.

Clause 9: The computer-implemented method of clause 8, wherein at least one of the one or more cameras is positioned to capture within its field of view at least one reflection from at least one of a window surface, a dashboard surface, a side panel surface, a center console surface, a seat surface, a mirror surface, or a display surface.

Clause 10: The computer-implemented method of clause 9, wherein the at least one reflection does not include a windshield reflection or a rear-facing mirror reflection.

Clause 11: The computer-implemented method of clause 9, wherein at least one of the at least one reflections comprises:
at least one surface reflection of at least one reflective surface.

Clause 12: The computer-implemented method of clause 1, wherein the based on the reflected image data, estimating the location of the one or more occupants of the vehicle space comprises:
based on the reflected image data, triangulating the location of the one or more occupants of the vehicle space.

Clause 13: The computer-implemented method of clause 1, wherein the d) using a deep learning model trained on vehicle space occupant reflection image data, performing eye tracking for at least one of the one or more occupants based on the face image data, the eye region image data, and head pose data comprises:
determining a point of regard (POR) of each eye of each of the one or more occupants;
determining an eye state of each eye of each of the one or more occupants; and
determining a gaze direction of each eye of each of the one or more occupants.

Clause 14: The computer-implemented method of clause 13, wherein the deep learning model comprises at least one of a convolutional neural network, a neural radiance field (NeRF), a neural radiance field to handle scenes with reflections (NeRFReN), or a generative pre-trained transformer network.

Clause 15: The computer-implemented method of clause 13, wherein the deep learning model comprises:
a deep learning network trained on face and eye images reflected from one or more surfaces within one or more vehicle spaces.

Clause 16: The computer-implemented method of clause 1, wherein the face image data and the eye region image data comprise:
at least one digital intensity image, wherein the at least one digital intensity image includes at least one visible eye region.

Clause 17: The computer-implemented method of clause 1, wherein the obtaining face image data further comprises:
associating at least one digital user identifier with each face in the face image data.

Clause 18: The computer-implemented method of clause 17, wherein the at least one digital user identifier comprises at least one anonymized unique digital user identifier.

Clause 19: A system configured for performing multi-user gaze tracking in a vehicle space through multi-surface optical reflections, the system comprising: one or more hardware processors configured by machine-readable instructions to:
receive reflected image data of one or more occupants of a vehicle space;
based on the reflected image data, estimate the location of the one or more occupants of the vehicle space;
obtain face image data, eye region image data, and head pose data from the reflected image data of one or more occupants of the vehicle space; and
using a deep learning model trained on vehicle space occupant reflection image data, perform eye tracking for at least one of the one or more occupants based on the face image data, the eye region image data, and head pose data.

Clause 20: A computer program product comprising a non-transitory computer-readable medium having instructions that, when executed by a computer, cause the computer to perform the operations of any of clauses 1-18.

In some implementations, computing platforms, remote platforms, and/or external resources may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platforms, remote platforms, and/or external resources may be operatively linked via some other communication media.

A given remote platform may include one or more processors configured to execute computer instruction sets. The computer program instruction sets may be configured to enable an expert or user associated with the given remote platform to interface with a gaze tracking system and/or external resources, and/or provide other functionality attributed herein to remote platforms. By way of non-limiting example, a given remote platform and/or a given computing platform may include one or more of a cloud or datacenter, a virtual private network, a server, a vehicle computer, a desktop computer, a laptop computer, a handheld computer, a tablet computing platform, a NetBook, a Smartphone, a gaming console, and/or other computing platforms.

External resources may include sources of information outside of a gaze tracking system proper, such as external entities participating with system, and/or other resources. In some implementations, some or all of the functionality attributed herein to external resources may be provided by resources included in a gaze tracking system.

Computing platforms may include non-transitory electronic storage operable to store any machine readable instructions, one or more processors, and/or other components. Computing platform may include communication lines, or ports to enable the exchange of information with a network and/or other computing platforms. Computing platforms may include a plurality of hardware, software, and/or firmware components operating together to provide the functionality attributed herein to computing platforms. For example, computing platforms may be implemented by one or more clouds of computing environments operating together as a computing platform.

Electronic storage may comprise non-transitory storage media that electronically stores information. The electronic storage media of electronic storage may include one or both of system storage that is provided integrally (i.e., substantially non-removable) with computing platforms and/or removable storage that is removably connectable to computing platforms via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from computing platforms, information received from remote platforms, and/or other information that enables computing platforms to function as described herein.

Processors may be configured to provide information processing capabilities in computing platforms. As such, processors may include one or more of a digital processor, an analog processor, a digital circuit designed to process information, an analog circuit designed to process information, a state machine, and/or other mechanisms for electronically processing information. In some implementations, processors may include a plurality of processing units. These processing units may be physically located within the same device, or processors may represent processing functionality of a plurality of devices operating in coordination. Processors may be configured to execute instruction sets and/or other modules by software; hardware; firmware; some combination of software, hardware, and/or firmware; and/or other mechanisms for configuring processing capabilities on one or more processors. As used herein, the term “instruction set” may refer to any structure, component, or set of components that enable the performance of the functionality attributed to the instruction set. This may include one or more physical processors during execution of processor readable instructions, the processor readable instructions, circuitry, hardware, storage media, or any other components.

In some implementations, the methods described herein may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations in response to instructions stored electronically on a non-transitory electronic storage medium. The one or more processing devices may include one or more devices configured through hardware, firmware, and/or software to be specifically designed for execution of one or more of the operations of the methods of this application.

Embodiments may also include acquiring eye region image data of a plurality of occupants within a field of view of at least one camera associated with a vehicle space. Embodiments may also include analyzing the eye region image data to determine at least one head position, 3D eye position, at least one gaze angle, at least one point-of-regard, and at least one eye state for at least one occupant relative to at least one camera associated with the vehicle space.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more medias are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively, or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a USB drive, a solid state memory device, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read-only, etc.)), and/or electrical circuitry forming a communications device (e.g., a modem, communications switch, optical-electrical equipment, etc.). Those having ordinary skill in the art will recognize that the subject matter described herein may be implemented in an analog or digital fashion or some combination thereof.

Those skilled in the art will recognize that at least a portion of the devices and/or processes described herein can be integrated into a data processing system. Those having ordinary skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method for performing gaze tracking in a vehicle space, the method comprising:
obtaining face image data, eye region image data, and head pose data for one or more occupants within a field of view of one or more cameras within a vehicle space,
wherein the face image data, eye region image data, and head pose data is reflected from one or more surfaces within the vehicle space;
evaluating the face image data, the eye region image data, and the head pose data for image quality; and
for image data meeting or exceeding one or more image quality parameters, determining eye tracking information for each of the one or more occupants based on the face image data, the eye region image data, and head pose data.

2. The computer-implemented method of claim 1, wherein the one or more cameras comprises at least one of a digital camera with a wide field-of-view (FOV), a plurality of cameras directed at one or more reflective surfaces within the vehicle space, or a plurality of cameras capturing one or more of direct and reflected images of the one or more occupants.

3. The computer-implemented method of claim 1, further comprising:
selecting one or more optimal views of each of the one or more occupants; and
estimating a position of at least one of the one or more occupants based on the selecting one or more optimal views of each of the one or more occupants, for multi-view localization.

4. The computer-implemented method of claim 3, wherein the multi-view localization is performed using camera triangulation of reflected image data captured by a single camera.

5. The computer-implemented method of claim 1, wherein the one or more surfaces comprises at least one of a diffuse surface or a specular surface.

6. The computer-implemented method of claim 1, wherein the one or more surfaces within the vehicle space comprises:
one or more of a highly reflective surface, a mirrored surface, a metal-coated surface, or a reflective plastic surface.

7. The computer-implemented method of claim 1, wherein the one or more image quality parameters comprises at least one of eye landmark detectability, image contrast, minimal intensity, image sharpness, or image resolution.

8. The computer-implemented method of claim 1, further comprising:
selecting image data from the one or more cameras based on the evaluating the face image data, the eye region image data, and the head pose data for image quality.

9. The computer-implemented method of claim 8, wherein the selecting image data from the one or more cameras based on the evaluating the face image data, the eye region image data, and the head pose data for image quality comprises:
dynamically selecting image data from the one or more cameras based on the evaluating the face image data, the eye region image data, and the head pose data for image quality.

10. The computer-implemented method of claim 9, wherein the dynamically selecting image data from the one or more cameras based on the evaluating the face image data, the eye region image data, and the head pose data for image quality is carried out in response to a change in at least one reflection.

11. The computer-implemented method of claim 9, wherein the dynamically selecting one or more cameras based on the evaluating the face image data, the eye region image data, and the head pose data for image quality is carried out in response to at least one movement of at least one occupant.

12. The computer-implemented method of claim 1, wherein at least one of the one or more cameras within the vehicle space is configured to capture within its field of view one or more surface reflections of at least one occupant of the vehicle space.

13. The computer-implemented method of claim 12, wherein at least one of the one or more cameras is positioned to capture within its field of view at least one reflection from at least one of a window surface, a dashboard surface, a side panel surface, a center console surface, a seat surface, a mirror surface, or a display surface.

14. The computer-implemented method of claim 1, wherein the one or more surfaces within the vehicle space does not include a windshield or a rear-facing mirror.

15. The computer-implemented method of claim 12, wherein at least one of the one or more surface reflections of at least one occupant of the vehicle space comprises:
at least one surface reflection of at least one reflective surface.

16. The computer-implemented method of claim 1, wherein the determining eye tracking information comprises:
determining, using an artificial intelligence model,
a) a point of regard (POR) of each eye of each of the one or more occupants;
b) an eye state of each eye of each of the one or more occupants; and
c) gaze direction of each eye of each of the one or more occupants.

17. The computer-implemented method of claim 16, wherein the artificial intelligence model comprises at least one of a convolutional neural network, a neural radiance field (NeRF), a neural radiance field to handle scenes with reflections (NeRFReN), or a generative pre-trained transformer network.

18. The computer-implemented method of claim 16, wherein the artificial intelligence model comprises:
a deep learning network trained on face and eye images reflected from one or more surfaces within one or more vehicle spaces.

19. The computer-implemented method of claim 1, wherein the face image data and the eye region image data comprise:
at least one digital intensity image, wherein the at least one digital intensity image includes at least one visible eye region.

20. The computer-implemented method of claim 1, wherein the obtaining face image data further comprises:
associating at least one digital user identifier with each face in the face image data.

21. The computer-implemented method of claim 20, wherein the at least one digital user identifier comprises at least one anonymized unique digital user identifier.

22. The computer-implemented method of claim 1, wherein the evaluating the face image data, the eye region image data, and the head pose data for image quality comprises:
receiving a) system calibration data; b) number of supported occupants data; and c) extracted image data; and
applying a rule set based on at least one of power optimization, camera location parameters, camera field-of-view (FOV) parameters, camera image quality, and eye tracking information quality for each face having a unique digital identifier.

23. The computer-implemented method of claim 22, wherein the system calibration data comprises at least one of:
camera setting data, resolution information, data processing and storage capability information, or system latency information.

24. The computer-implemented method of claim 22, wherein the extracted image data comprises at least one of:
digital unique identifier data, eye state data, head pose data, eye gaze data, Point-of-Regard (POR) data, eye region intensity level data, or eye position data.

25. The computer-implemented method of claim 24, wherein the eye state data comprises at least one of eye open, eye closed, eye partially closed, eye X percent closed, or eye X percent open.

26. The computer-implemented method of claim 22, wherein the rule set comprises at least one decision tree structure.

27. The computer-implemented method of claim 22, wherein the power optimization comprises:
information about the number of cameras providing image data per digital unique identifier.

28. The computer-implemented method of claim 22, wherein the camera location parameters comprise:
information about the number and 6DoF location of cameras to be used for gaze tracking and their respective reflective surfaces within the FOV of each camera.

29. The computer-implemented method of claim 22, wherein the camera image quality comprises at least one of:
eye region presence or absence in an image, eye state, resolution of eye region (pixels-per-millimeter) in an image, illumination of eye region in an image, PoR information, gaze direction information, head position information, or head orientation information.

30. The computer-implemented method of claim 22, wherein the applying a rule set based on at least one of power optimization, camera location parameters, camera image quality; and eye tracking information quality for each face having a unique digital identifier comprises:
setting a threshold value for at least one of power optimization, camera location parameters, camera image quality; and eye tracking information quality for each face having a unique digital identifier.

31. A system operable to perform gaze tracking in a vehicle space, the system comprising:
one or more imaging devices configured to obtain face image data, eye region image data, and head pose data for one or more occupants within a vehicle space and within a field of view of the one or more imaging devices,
wherein the face image data, eye region image data, and head pose data is reflected from one or more surfaces within the vehicle space;
circuitry configured to evaluate the face image data, the eye region image data, and the head pose data for image quality; and
circuitry configured to determine eye tracking information for each of the one or more occupants based on the face image data, the eye region image data, and the head pose data if at least one of the face image data, the eye region image data, or the head pose data meets or exceeds one or more image quality parameters.

32. A computer program product comprising a non-transitory computer-readable medium having instructions that, when executed by a computer, cause the computer to perform the operations of claim 1.
